(19) United States
(12) Patent Application Publication
(10) Pub. No.: US 2025/0001720 A1
(43) Pub. Date: Jan. 2, 2025

(54) MANUFACTURE OF TAPERED COMPOSITE PANELS

(71) Applicant: AIRBUS OPERATIONS LIMITED, Bristol (GB)

(72) Inventors: Richard HEWSON, Bristol (GB); Antony Charles PEACOCK, Bristol (GB); David LIVERSAGE, Bristol (GB); Andrew SCAIFE, Bristol (GB)

(21) Appl. No.: 18/756,468

(22) Filed: Jun. 27, 2024

(30) Foreign Application Priority Data
Jun. 28, 2023 (GB) 2309717.3

(51) Int. Cl. B32B 3/26; B29C 70/46; B29K 105/08; B29L 31/30; B32B 5/02; B32B 5/26

(52) U.S. Cl. CPC B32B 3/263; B29C 70/46; B32B 5/02; B32B 5/26; B29K 2105/08; B29K 2995/0097; B29L 2031/3085; B32B 2250/20; B32B 2250/44; B32B 2260/023; B32B 2260/046; B32B 2605/18

(57) ABSTRACT

A composite manufacture assembly is disclosed including a pair of closed mould tools for pressing a composite laminate panel therebetween, the closed mould tools having opposing inner surfaces that define an inner cavity that decreases in height along a span of the inner cavity in accordance with a curved rational function, the decrease in height corresponding to a designed thickness of the composite panel. The composite laminate panel including a stack of fibre-reinforced composite plies; a plurality of sets of ply drops spaced along a span of the composite laminate panel at which a corresponding set of plies terminate such that the thickness of the composite laminate panel varies along the span in accordance with the position and thickness of the sets of ply drops, each set of ply drops comprising one or more ply drops.

### CROSS RELATED APPLICATION

This application claims priority to United Kingdom Patent Application GB 2309717.3, filed Jun. 28, 2023, the entire contents of which is hereby incorporated by reference.

### FIELD OF THE INVENTION

The present invention relates to a composite manufacture assembly and a method of manufacturing a composite laminate panel.

### BACKGROUND OF THE INVENTION

Aircraft components are increasingly made from fibre-reinforced composite materials due to the high specific properties (i.e. the material property per mass density of material) compared to conventional materials, such as metals. Fibre-reinforced composite structures are typically formed of layered plies stacked to form a composite structure of the required structure.

A reduction in the thickness of composite components can be achieved by terminating plies at discrete locations, otherwise referred to as ply drops, that reduce the thickness of the component according to the thickness of the ply. This can provide significant weight and cost benefits, but also introduces stress discontinuities that need to be carefully managed.

Design guidelines for introducing ply drops are generally quite conservative to ensure these discontinuities are accounted for in the overall structure both by overdesigning the component and following design guidelines on staggering the ply drops over a minimum length of the component. These design guidelines are continually reviewed and updated to adjust the ramp rate of the ply drops in order to provide more design freedom when developing composite components.

These design principles can become more conservative as new manufacturing techniques are adopted, such as closed moulding, and this can offset some of the advantages of using these manufacturing techniques.

### SUMMARY OF THE INVENTION

A first aspect of the invention provides a composite manufacture assembly, comprising: a pair of closed mould tools for pressing a composite laminate panel therebetween, the closed mould tools having opposing inner surfaces that define an inner cavity that decreases in height along a span of the inner cavity in accordance with a curved rational function, the decrease in height corresponding to a designed thickness of the composite panel; the composite laminate panel comprising: a stack of fibre-reinforced composite plies; a plurality of sets of ply drops spaced along a span of the composite laminate panel at which a corresponding set of plies terminate such that the thickness of the composite laminate panel varies along the span in accordance with the position and thickness of the sets of ply drops, each set of ply drops comprising one or more ply drops; each set of ply drops positioned along a respective span portion of the span of the panel, each respective span portion defining a portion of the span of the panel at which the designed thickness decreases in dependence on the thickness of the respective set of plies to be terminated; and wherein the position of each set of ply drops along a respective span portion between a mid-thickness position and a zero-thickness position of the designed thickness decrease.

A second aspect of the invention provides a method of manufacturing a composite laminate panel, comprising: designing a profile of the composite laminate panel, the profile defining a designed thickness of the panel decreasing along a span of the composite laminate panel according to a curved rational function; determining a layup of a series of fibre-reinforced composite plies to form the composite laminate panel, each composite ply having a respective thickness; determining a number of sets of ply drops at which respective sets of plies terminate required to provide a thickness decrease of the composite laminate panel along the span in accordance with the rational function; determining a set of respective span portions along the span of the composite laminate panel, each respective span portion defining a portion of the span of the panel at which the designed thickness decreases in dependence on the thickness of the respective set of plies to be terminated, determining the position of each set of ply drops along a respective span portion between a mid-thickness position and a zero-thickness position of the designed thickness decrease; and laying up a set composite plies to form a composite laminate panel preform according to the determined layup and position of the plurality of sets of ply drops.

Advantageously, this systematic means of determining the position of the ply drops helps to reduce any discrepancies between the designed profile of the composite panel and the moulding tool, for instance a closed moulding tool where constraints on the composite panel preform can be particularly tight, whilst minimising the formation of areas with low fibre volume fraction and other defects.

The decrease in height between ends of the span of the inner cavity may have an overall slope of 0.5% or less, optionally 0.3% or less, and optionally 0.2% or less. Similarly, the decrease in height of the designed composite laminate panel may have an overall slope of 0.5% or less, optionally 0.3% or less, and optionally 0.2% or less.

The distance between each of the sets of ply drops may increase or decrease along the span of the composite laminate panel.

The designed thickness may decrease along the span portion by the thickness of the respective set of plies to be terminated at the respective span portion.

The plurality of sets of ply drops may comprise at least five sets of ply drops.

The position of each set of ply drops along a respective span portion may be between a quarter-thickness position and a zero-thickness position of the designed thickness decrease.

The curved rational function may be a conic function.

The curved rational function may be one of a hyperbolic function, parabolic function, elliptical function or polynomial function.

Each set of ply drops may comprise a single ply drop.

Each set of ply drops may comprise a plurality of ply drops.

The ply drops within each set of ply drops may define a slope of 2.5% or more.

The composite laminate panel may have an upper composite ply and a lower composite ply, and wherein each ply drop is a termination of a composite ply located between the upper and lower composite plies.

The plies to be terminated may have a stacking sequence in the through-thickness direction of the panel, and the spanwise order in which the plies are terminated is different to the stacking sequence.

The composite laminate panel may have curvature in two orthogonal directions such that the height of the inner cavity decreases in height along a width of the inner cavity.

The height along the width of the inner cavity may decrease in accordance with a curved rational function.

The composite laminate panel may have a ratio of span-to-thickness and width-to-thickness of at least 100:1.

The composite laminate panel may be an aerodynamic skin panel.

The composite laminate panel is an aircraft skin panel.

The composite laminate panel may be part of an aircraft wingtip or winglet.

The method may comprise: providing a pair of closed mould tools having opposing inner surfaces that, when the closed mould tools are pressed together, define an inner cavity having the same profile as the designed profile of the composite laminate panel; placing the composite laminate panel between the closed mould tools; and pressing the closed mould tools together to consolidate the composite laminate panel preform.

### BRIEF DESCRIPTION OF THE DRAWINGS

Embodiments of the invention will now be described with reference to the accompanying drawings, in which:

FIG. 1 shows an aircraft;

FIG. 2 shows a wing tip device;

FIG. 3 shows a ply terrace on a composite panel;

FIG. 4 shows a designed composite panel;

FIG. 5 shows a ply drop sequence of the designed composite panel;

FIG. 6A shows a mid-thickness position of a ply drop;

FIG. 6B shows a quarter-thickness position of a ply drop;

FIG. 6C shows a zero-thickness position of a ply drop;

FIG. 7 shows the layup of the composite panel preform;

FIG. 8 shows the preform consolidated between opposed closed mould tools;

FIG. 9 shows the cured composite laminate panel;

FIG. 10 shows an alternative sequence of the ply drops different to the stacking sequence;

FIG. 11a shows ply drops arranged along the span of a panel according to a convex parabolic function;

FIG. 11b shows ply drops arranged along the span of a panel according to a convex hyperbolic function;

FIG. 11c shows ply drops arranged along the span of a panel according to a concave parabolic function; and

FIG. 11d shows ply drops arranged along the span of the panel according to a concave hyperbolic function.

### DETAILED DESCRIPTION OF EMBODIMENT(S)

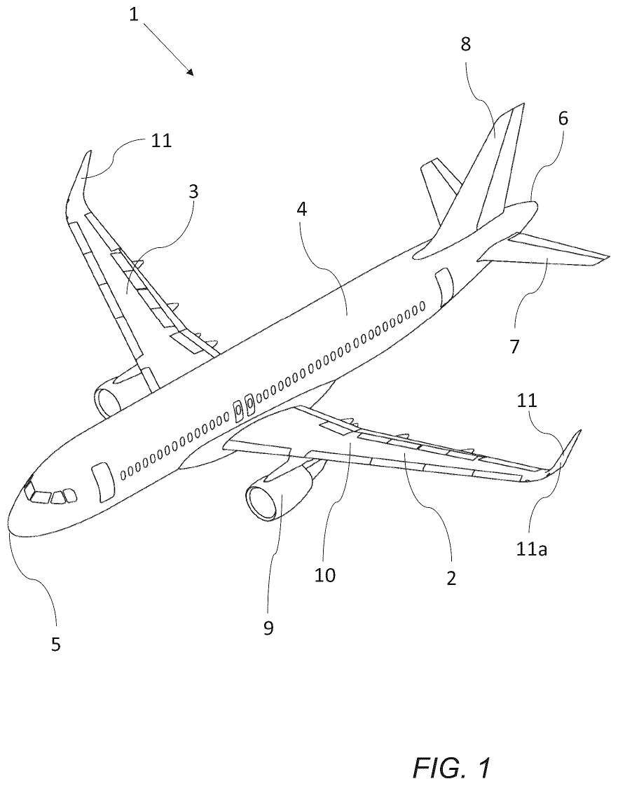

FIG. 1 shows an existing aircraft 1 with port and starboard fixed wings 2, 3, engines 9, a fuselage 4 with a nose end 5 and a tail end 6, the tail end 6 including horizontal and vertical stabilising surfaces 7, 8. The aircraft 1 is a typical jet passenger transport aircraft but the invention is applicable to a wide variety of fixed wing aircraft types, including commercial, military, passenger, cargo, jet, propeller, general aviation, etc. with any number of engines attached to the wings or fuselage.

Each wing 2, 3 of the aircraft 1 has a cantilevered structure with a length extending in a span-wise direction from a root to a tip, the root being joined to the aircraft fuselage 4. The wings include a main fixed wing portion 10 and a wing tip device 11 outboard of the main fixed wing portion 10.

The wing tip device 11 shown is a winglet 11a with an upwardly projecting lifting surface (alternatively referred to as a sharklet), although it will be appreciated the invention is applicable to a wide range of highly curved composite panels. These may include aircraft components such as portions of the wing 2, 3, alternately shaped wing tip devices 10, fuselage panels and the like, as well as composite panels for other industries, such as vehicle body panels.

The thickness of composite panels used in such structural applications is typically varied to tailor the static and dynamic performance of the panel, which thereby requires management of the composite laminate thickness. The standard practice has been to manage laminate thickness changes by dropping plies in a ‘terracing’ manner, partly to simplify the end-to-end tasking and processing of the laminates panels, with any detrimental effects of the ply drops considered on a localised level to help prevent any significant stress concentrations.

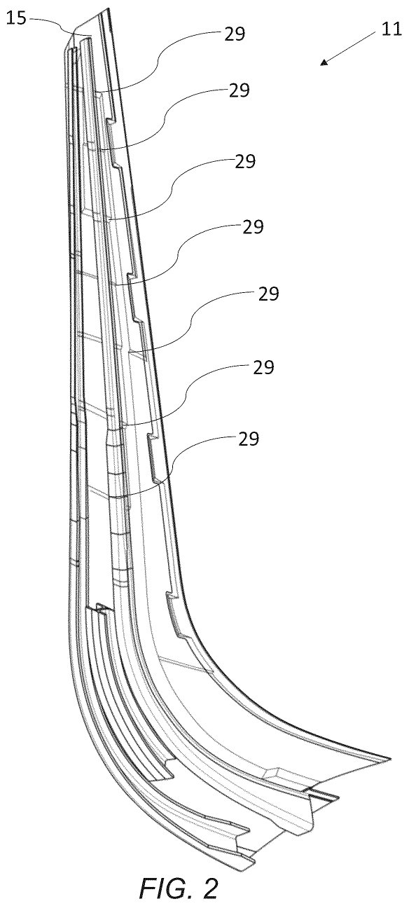

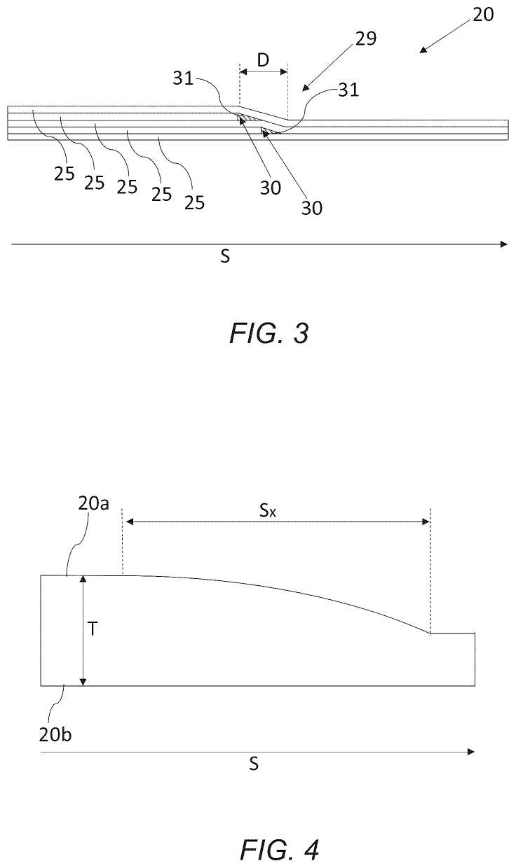

An example of terracing a series of ply drops is seen in FIG. 2, in which the thickness of the outer skin panel 15 of the winglet 11a is decreased in batches at a series of ply terraces 29. FIG. 3 shows a close-up of an example ply terrace 29, in which successive ply drops 30 are spread across a relatively short distance D of the composite laminate panel 20 to provide a decrease in the thickness of the composite laminate panel 20. In this example only two plies 25 are dropped, although it will be appreciated that a ply drop terrace 29 may comprise many more ply drops 30, for example more than five. Each ply drop 30 is generally accompanied by a resin pocket 31 or other defect(s) potentially detrimental to structural performance. Design guidelines for ply drops 30 typically specify minimum spacing between the ply drops 30 along the span S of the composite laminate panel 20 to reduce stress concentrations, with slopes of between 2.5% and 10% typical (i.e. ramp rates of thickness-to-length of between 1:40 and 1:10).

Composite manufacture techniques and processes continually evolve and improve, such that minimising ply drop spacing may no longer be a prime driver, and may, if fact, introduce unwelcome constraints, especially within the context of closed moulding manufacturing processes, such as Resin Transfer Moulding (RTM), and Same Qualified Resin Transfer Moulding (SQRTM).

This invention relates to a systematic means of determining the position of ply drops 30 in a manner that can help provide structural performance benefits, weight savings, and material utilization benefits, as well as ease the creation of closed mould tools.

To achieve this, the overall profile of a composite panel 20 is designed, such that the curvature of the outer surfaces of the composite panel 20 and the thickness T of the composite panel 20 are predetermined. FIG. 4 shows an example of a designed composite panel 20 in which the profile of the upper surface 20a includes a curved portion (Sx), with a thickness T of the composite panel 20 that varies in the span direction. Incorporated into this design may be the configuration of the fibre-reinforced composite plies 25 for forming the composite panel 20, such that the lay-up of the composite panel 20 is known in terms of the material composition of the plies 25, the stacking sequence of the plies 25, and the individual thicknesses of each ply 25. The plies 25 are continuous fibre-reinforced composite plies 25, although chopped fibre-reinforced composites plies 25, composite material tapers, filaments and veils may be utilised.

As previously discussed, current practice has been to semi-arbitrarily space the ply drops 30 in a manner that simplifies the end-to-end tasking and processing of composite laminate panels, whilst meeting the structural performance requirements. This can result in inefficient use of materials and overdesigning of the structure.

The designed composite panel 20 shown in FIG. 4 has a designed thickness T that varies along a section Sx of its span S according to a curved rational function, f (x). In the present example, the curved rational function is an arc of an ellipse, although a non-exhaustive list of rational functions includes conic functions, hyperbolic functions, parabolic functions, and high-order polynomial functions (i.e. second order and above), with it being appreciated there may be overlap between these terms in some instances. The function may be non-circular.

The information related to the designed layup of the fibre-reinforced composite plies 25 and the profile of the composite laminate panel 20 can then be used to determine the required number of ply drops 30 to achieve the decrease in thickness across the span S of the designed composite laminate panel 20. For instance, the combined thickness of all plies 25 to be terminated will be equal to the decrease in thickness of the composite laminate panel 20. The plies 25 may each have the same thickness, or there may be plies 25 having different thicknesses to other plies 25.

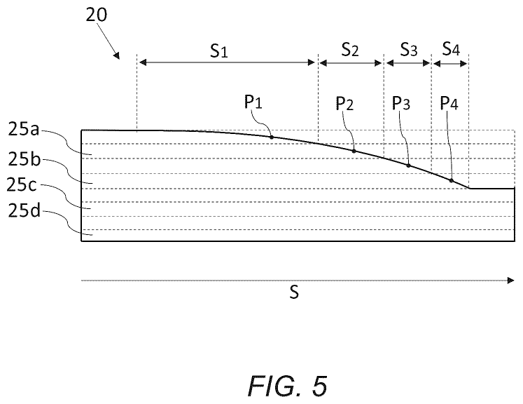

The position P of the ply drops 30 is then determined according to a set of design principles, illustrated by FIG. 5, that help minimise manufacturing defects that can be particularly prevalent in closed mould manufacturing processes where the constraints on the geometry of the composite part are generally greatest.

Specifically, a set of span portions S₁, S₂, S₃, S₄ are defined along the span of the composite laminate panel 20 such that each ply drop 30a, 30b, 30c, 30d is associated with a respective span portion S₁-S₄. In other words, a first ply drop 30a is associated with a first span portion S₁, and so on. The span portions S₁-S₄ are calculated by identifying a span portion S₁-S₄ for each ply drop 30a-d at which the change in designed thickness of the designed composite panel 20 is the same as the thickness of the respective set of plies 25a, 25b, 25c, 25d to be terminated, such that the thickness of a first set of plies 25a to be terminated is the same as the change in designed thickness along the respective span portion S₁.

It will be appreciated that in some examples, the designed change in thickness will not exactly correlate to the thicknesses of the plies 25, for example the number of plies 25 required to exactly match the thickness variation may not be an integer. In such cases, the span portions S₁-S₄ may be increased or decreased in size to account for this, although any change will be proportional for each span portion S₁-S₄.

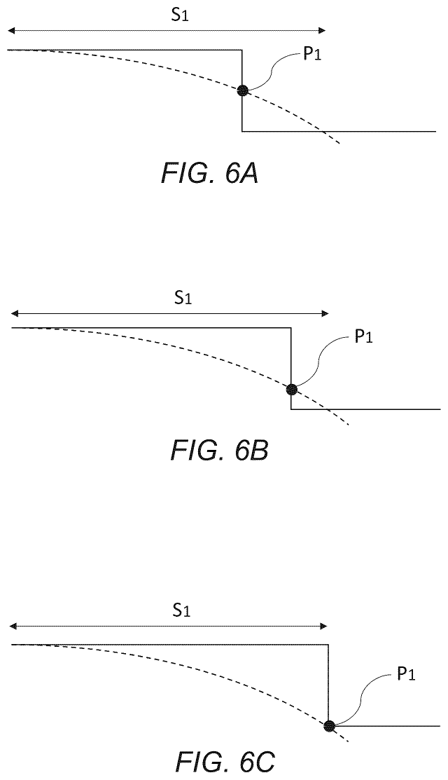

The position P₁, P₂, P₃, P₄ of each ply drop 30a-d will be at a position along the respective span portion S₁-S₄, and between a mid-thickness position (See FIG. 6A) and a zero-thickness position (See FIG. 6C) along the respective span portion S₁-S₄ of the designed thickness decrease. For reference, the mid-thickness position is the spanwise location from one end of the span portion to the opposing end at which the change in thickness is half the total change in thickness between the ends. Said differently, each of the ply drops 30 will be cut in half by the profile of the designed composite panel 20. Meanwhile, the zero-thickness position is the spanwise location at the end of the span portion at the lowest thickness position of the span portion. It will be understood that the exact position will be subject to manufacturing tolerances, which are preferably no more than 10 mm, and may be less than 5 mm.

In this manner, the positions P₁-P₄ of the ply drops 30a-d are determined in a manner that aims to optimize the location of the ply drops 30a-d and thereby improve the overall quality of the composite panel 20. In particular, a position P₁-P₄ of the ply drops 30a-d at a mid-thickness location minimizes the discrepancies with the ply drops 30a-d and the variation in thickness of the designed composite panel 20. Whereas a zero-thickness position can help prevent the formation of voids and dry fibres. The ply drops 30a-d will generally be positioned between the mid-thickness and zero-thickness positions.

The preferred ‘thickness position’ of the ply drops 30a-d will generally be a function of composite panel 20 thickness. A relatively thicker panel 20 (or position of the same panel 20) can be more tolerant to integrating the terminated ply 25a-d into the ply stack than a thin panel 20, and therefore a position towards the zero-thickness position may be preferable, whereas the thin panel 20 may require the ply drops 30a-d to be position closer to the quarter-thickness position (See FIG. 6B).

The position P₁-P₄ of the ply drops 30a-d will generally be determined in a manner that ensures the fibre volume fraction remains relatively constant throughout the panel 20 (i.e. biasing towards the zero-thickness position), so as to avoid resin dry areas and the like, whilst not over-constraining as a result of the discrepancy between the designed profile of the composite panel 20 (i.e. biasing towards the mid-thickness position). The preferred position will generally be between the quarter-thickness and zero-thickness positions (See FIGS. 6B and 6C).

It will be understood that each span portion S₁-S₄ is associated with a single ply drop 30, with each span portion span portion S₁-S₄ arranged adjacent one another so as to be continuous across the span S.

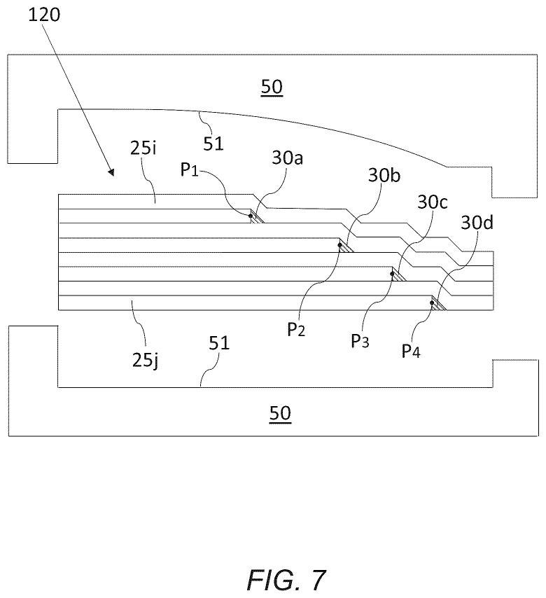

It will be appreciated that the preferred positioning of the ply drops 30 may be determined in an iterative process given the number of variables in the layup (e.g. ply orientation, ply thickness, material, and the specific plies to be dropped, and the sequence in which they are dropped) and the competing structural demands. For instance, among the many variables, it will be appreciated that different plies 25 may be terminated, or in a different sequence, through the thickness of the designed composite panel 20 (i.e. in some examples, the plies 25 may be terminated non-sequentially in the through-thickness direction) and/or there may be continuous plies 25 extending across the span portion S₁-S₄ located either side of one or more of the plies 25 that are terminated. Any of the plies 25 may be terminated, although typically this will not include outer plies due to the increased prevalence of surface delamination and other associated defects, such that the upper composite ply 25i and a lower composite ply 25j does not terminate to form a ply drop 30 but instead each ply drop 30 is a termination of a composite ply 25 located between the upper and lower composite plies 25i, 25j (See FIG. 7).

The resulting arrangement of the ply drops 30a-30d from this process is illustrated by FIG. 7, in which it can be seen that, prior to consolidation between the opposing closed mould tools 50, the composite preform 120 has an overall profile that generally approximates the profile of the designed composite panel 20 (the designed profile of the composite panel 20 indicated by the profile of the closed mould tools 50) in a manner that best ensures the final quality of the part. In this manner, the potentially detrimental effects of discrepancies between the composite preform 120 and the closed mould tools 50 caused at the ply drop 30 locations are minimized, such as the occurrence of resin rich areas, dry fibres, and inter-ply fibre interleaving.

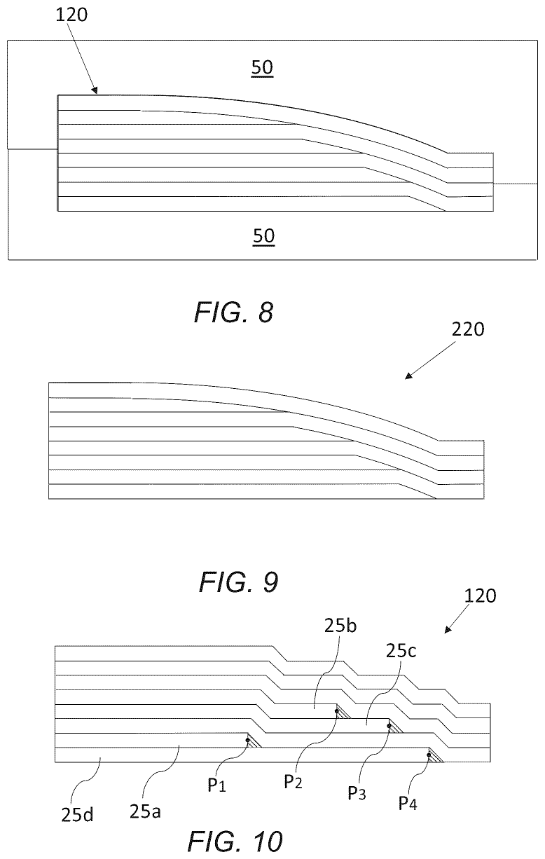

Upon finalizing the composite preform 120, the closed mould tools 50 are pressed together to consolidate and cure the composite laminate panel preform 120 (See FIG. 8) to form the final, cured composite laminate panel 220 (See FIG. 9). The pair of closed mould tools 50 have opposing inner surfaces 51 that, when the closed mould tools 50 are pressed together, define an inner cavity having the same profile as the designed profile of the composite laminate panel 20, and thereby the composite laminate panel preform 120 once consolidated.

It will be appreciated that the benefits of the present invention are greater the more complex the curvature of the designed composite panel 20, firstly in terms of achieving a higher quality composite part, and secondly in terms of providing a methodology that can speed up decision relating to the positioning of the ply drops 30 and thereby increase the manufacturing and processing rates, as well as potentially help in narrowing the variables in any optimisation of the structure. The invention may therefore be particularly advantageous for non-circular profiles in which the curvature of the composite part 20 varies along the span.

In the present case, reference to the span of the panel 20, 120, 220 refers to a panel 20, 120, 220 in which the span is greater than the width and thickness of the panel 20, 120, 220. The span S, the curved portion Sx, and the span portions S₁-S₄ may each have a length at least a magnitude greater than the thickness of the panel 20, 120, 220. The composite laminate panel 20, 120, 220 may have a ratio of span-to-thickness and width-to-thickness of at least 100:1.

Typical wing tip devices 11 may be more than 2 metres in length, with ply thicknesses generally ranging between 0.2 millimetres and 0.5 millimetres, with an decrease in height between ends of the curved portion Sx defining an overall slope of 0.5% or less (i.e. a ramp rate of thickness-to-length of 1:200 or less), or perhaps 0.3% or less (i.e. a ramp rate of thickness-to-length of 1:333 or less), or even 0.2% or less (i.e. a ramp rate of thickness-to-length of 1:500 or less).

The examples described above refer to the termination of individual ply drops 30a-d in each span portion S₁-S₄. In alternative examples, each span portion S₁-S₄ may include a plurality of ply drops 30a-d referred to as a set of ply drops 30 that are tightly packed such that each set of ply drops 30 defines a slope of 2.5% or more (i.e. a ramp rate of thickness-to-length of 1:40 or more). Such an arrangement may find a compromise between the improved correlation between the outer profile of the unconsolidated composite laminate panel preform 120 and the closed mould tools 50, and processing expediency of the layup process. In this case, it is intended that the total thickness of all ply drops 30 in a set of ply drops 30 is taken into account when determining the mid-thickness, quarter-thickness and zero-thickness positions.

Whilst the abovementioned examples describe the terminate of plies 25 across the span S of a panel 20, 120, 220, it will be appreciated that the curvature may extend in two orthogonal directions such that particular advantage is found in using the design methodology to determine the position of ply drops 30 in the width direction in addition to the span direction of the panel 20.

As discussed previously, the plies 25 may be terminated in a non-sequential order. FIG. 10 shows an example of such a non-sequential ply 25 termination arrangement. Specifically, the plies 25 to be terminated have a stacking sequence in the thickness direction, and the spanwise order in which the plies 25 are terminated is different to the stacking sequence.

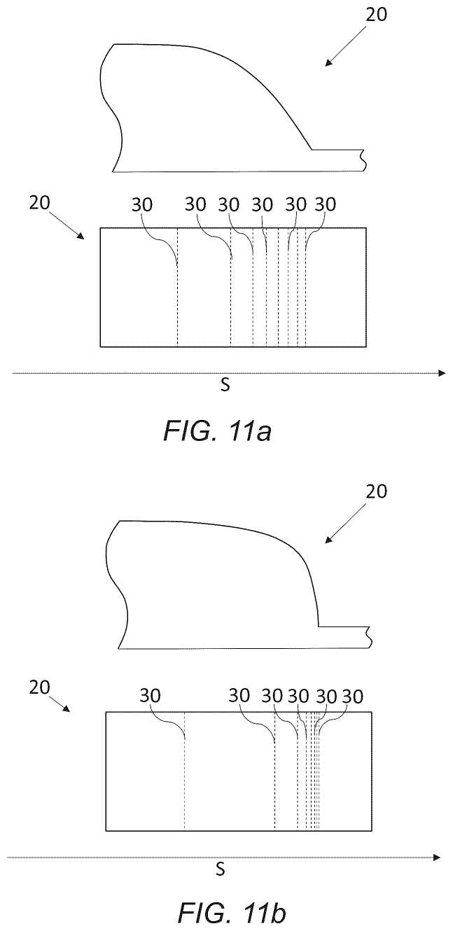

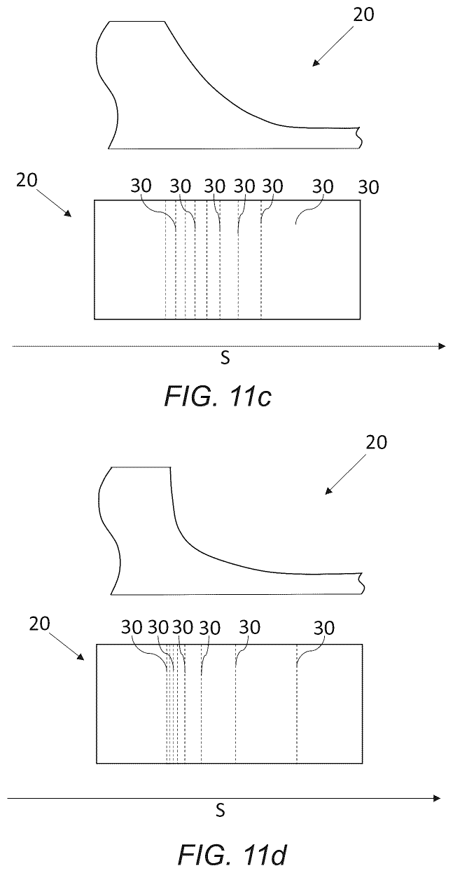

Further examples of possible rational functions are illustrated in FIGS. 11a to 11d. FIG. 11a shows ply drops 30 arranged along the span S of the panel 20 according to a convex parabolic function, FIG. 11b shows ply drops 30 arranged along the span S of the panel 20 according to a convex hyperbolic function, FIG. 11c shows ply drops 30 arranged along the span S of the panel 20 according to a concave parabolic function, and FIG. 11d shows ply drops 30 arranged along the span S of the panel 20 according to a concave hyperbolic function. It will be appreciated that for non-circular rational functions, such as those shown above, the distance between the ply drops 30 (or sets of ply drops 30) may increase or decrease continually along the span S of the composite laminate panel 20, 120, 220.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

1. A composite manufacture assembly, comprising:
a pair of closed mould tools for pressing a composite laminate panel therebetween, the closed mould tools having opposing inner surfaces that define an inner cavity that decreases in height along a span of the inner cavity in accordance with a curved rational function, the decrease in height corresponding to a designed thickness of the composite panel;
the composite laminate panel comprising:
a stack of fibre-reinforced composite plies;
a plurality of sets of ply drops spaced along a span of the composite laminate panel at which a corresponding set of plies terminate such that the thickness of the composite laminate panel varies along the span in accordance with the position and thickness of the sets of ply drops, each set of ply drops comprising one or more ply drops;
each set of ply drops positioned along a respective span portion of the span of the panel, each respective span portion defining a portion of the span of the panel at which the designed thickness decreases in dependence on the thickness of the respective set of plies to be terminated; and
wherein the position of each set of ply drops along a respective span portion is between a mid-thickness position and a zero-thickness position of the designed thickness decrease.

2. The composite manufacture assembly of claim 1, wherein the decrease in height between ends of the span of the inner cavity has an overall slope of 0.5% or less.

3. The composite manufacture assembly of claim 1, wherein the distance between each of the sets of ply drops increases or decreases along the span of the composite laminate panel.

4. The composite manufacture assembly of claim 1, wherein the designed thickness decreases along the span portion by the thickness of the respective set of plies to be terminated at the respective span portion.

5. The composite manufacture assembly of claim 1, wherein the plurality of sets of ply drops comprise at least five sets of ply drops.

6. The composite manufacture assembly of claim 1, wherein the position of each set of ply drops along a respective span portion is between a quarter-thickness position and a zero-thickness position of the designed thickness decrease.

7. The composite manufacture assembly of claim 1, wherein the curved rational function is a conic function.

8. The composite manufacture assembly of claim 1, wherein the curved rational function is one of a hyperbolic function, parabolic function, elliptical function or polynomial function.

9. The composite manufacture assembly of claim 1, wherein each set of ply drops comprises a single ply drop.

10. The composite manufacture assembly of claim 1, wherein each set of ply drops comprises a plurality of ply drops.

11. The composite manufacture assembly of claim 10, wherein the ply drops within each set of ply drops define a slope of 2.5% or more.

12. The composite manufacture assembly of claim 1, wherein the composite laminate panel has an upper composite ply and a lower composite ply, and wherein each ply drop is a termination of a composite ply located between the upper and lower composite plies.

13. The composite manufacture assembly of claim 1, wherein the plies to be terminated have a stacking sequence in the through-thickness direction of the panel, and the spanwise order in which the plies are terminated is different to the stacking sequence.

14. The composite manufacture assembly of claim 1, wherein the composite laminate panel has curvature in two orthogonal directions such that the height of the inner cavity decreases in height along a width of the inner cavity.

15. The composite manufacture assembly of claim 1, wherein the height along the width of the inner cavity decreases in accordance with a curved rational function.

16. The composite manufacture assembly of claim 1, wherein the composite laminate panel has a ratio of span-to-thickness and width-to-thickness of at least 100:1.

17. The composite manufacture assembly of claim 1, wherein the composite laminate panel is an aerodynamic skin panel.

18. The composite manufacture assembly of claim 1, wherein the composite laminate panel is an aircraft skin panel.

19. The composite manufacture assembly of claim 1, wherein the composite laminate panel is part of an aircraft wingtip or winglet.

20. A method of manufacturing a composite laminate panel, comprising:
designing a profile of the composite laminate panel, the profile defining a designed thickness of the panel decreasing along a span of the composite laminate panel according to a curved rational function;
determining a layup of a series of fibre-reinforced composite plies to form the composite laminate panel, each composite ply having a respective thickness;
determining a number of sets of ply drops at which respective sets of plies terminate required to provide a thickness decrease of the composite laminate panel along the span in accordance with the rational function;
determining a set of respective span portions along the span of the composite laminate panel, each respective span portion defining a portion of the span of the panel at which the designed thickness decreases in dependence on the thickness of the respective set of plies to be terminated,
determining the position of each set of ply drops along a respective span portion between a mid-thickness position and a zero-thickness position of the designed thickness decease; and
laying up a set composite plies to form a composite laminate panel preform according to the determined layup and position of the plurality of sets of ply drops.

21. The method of claim 20, wherein the designed thickness decreases along the span portion by the thickness of the respective set of plies to be terminated at the respective span portion.

22. The method of claim 20, wherein the position of each set of ply drops along a respective span portion is between a quarter-thickness position and a zero-thickness position of the designed thickness decrease.

23. The method of claim 20, wherein the decrease in height of the designed composite laminate panel has an overall slope of 0.5% or less.

24. The method of claim 20, further comprising:
providing a pair of closed mould tools having opposing inner surfaces that, when the closed mould tools are pressed together, define an inner cavity having the same profile as the designed profile of the composite laminate panel;
placing the composite laminate panel between the closed mould tools; and
pressing the closed mould tools together to consolidate the composite laminate panel preform.
